(19) United States
(12) Patent Application Publication
(10) Pub. No.: US 2025/0343744 A1
(43) Pub. Date: Nov. 6, 2025

(54) SYSTEMS AND METHODS FOR LOCATION ACCURACY ESTIMATION OVER A WIRELESS NETWORK

(71) Applicant: VERIZON PATENT AND LICENSING INC., Basking Ridge, NJ (US)

(72) Inventors: Jack Anthony SMITH, Melissa, TX (US); Chin CHIU, Allen, TX (US); Asif Dawoodi GANDHI, Edison, NJ (US); Alpaslan Gence SAVAS, Summit, NJ (US)

(73) Assignee: VERIZON PATENT AND LICENSING INC., Basking Ridge, NJ (US)

(21) Appl. No.: 18/655,465

(22) Filed: May 6, 2024

(51) Int. Cl. H04L 43/0811; H04L 5/00; H04W 24/10; H04W 64/00

(52) U.S. Cl. CPC H04L 43/0811; H04L 5/0051; H04W 24/10; H04W 64/00

(57) ABSTRACT

Disclosed are systems and methods for a location estimation accuracy framework that operates on and/or in connection with a cellular network(s) to determine and estimate the location of user equipment (e.g., mobile devices) within and/or across cellular networks. The disclosed framework can execute operations that leverage a combination of Cell-ID information, GPS technology, timing measurements, and network-based positioning techniques to deliver accurate location information, enabling a wide range of location-based services and applications. The framework leverages determine path loss values for direct and/or indirect paths between UE and cell sites to determine locations of the UE, for which network services can be based and/or provided.

### BACKGROUND INFORMATION

3GPP (3rd Generation Partnership Project) is a collaboration between groups of telecommunications associations, known for developing standards for mobile telecommunications, including Global System for Mobile Communications (GSM), Universal Mobile Telecommunications System (UMTS) and Long Term Evolution (LTE). 3GPP standards provide functionality for location-based services (LBS) for mobile devices.

### BRIEF DESCRIPTION OF THE DRAWINGS

The features and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1A is a block diagram of an example network architecture according to some embodiments of the present disclosure;

FIG. 1B is a block diagram illustrating components of an exemplary system according to some embodiments of the present disclosure;

FIG. 2 depicts a non-limiting example embodiment of a network configuration according to some embodiments of the present disclosure;

FIGS. 3A-3B illustrate exemplary workflow according to some embodiments of the present disclosure;

FIG. 4 depicts a non-limiting example embodiment of a network configuration and workflow according to some embodiments of the present disclosure;

FIG. 5 illustrates a non-limiting example embodiment of a network architecture according to some embodiments of the present disclosure; and

FIG. 6 is a block diagram illustrating a computing device showing an example of a client or server device used in various embodiments of the present disclosure.

### DETAILED DESCRIPTION OF EXAMPLE EMBODIMENTS

3GPP standards play a role in enabling LBS for mobile devices across cellular networks. 3GPP standards provide a framework for various methods and protocols that facilitate the determination and estimation of a mobile device's location. One approach can involve utilizing cell identification (Cell-ID) information, where each base station in a network covers a specific geographical area. By knowing which base station a device is connected to, the network can approximate its location within the coverage area. Enhanced Cell-ID techniques further refine this process by considering additional parameters such as signal strength and timing advance, enhancing location accuracy.

3GPP standards can also support Assisted GPS (A-GPS), which combines traditional GPS technology with assistance data obtained from the mobile network. This assistance data includes information about nearby base stations and their timing, which aids the mobile device in acquiring GPS signals faster and improving location accuracy, especially in urban areas with obstructed GPS signals.

Observed Time Difference of Arrival (OTDOA) is another technique supported by 3GPP standards, where the network calculates a device's location based on the differences in arrival times of signals from multiple base stations. By triangulating the device's position using these timing differences, the network can estimate the device's location with greater accuracy.

Thus, 3GPP standards can facilitate the exchange of cell identity information between operators, allowing for improved location accuracy, particularly in areas where devices roam between different networks. Additionally, network-based positioning methods defined by 3GPP utilize measurements collected by the network from the mobile device to estimate its location, providing an alternative approach to GPS-based methods.

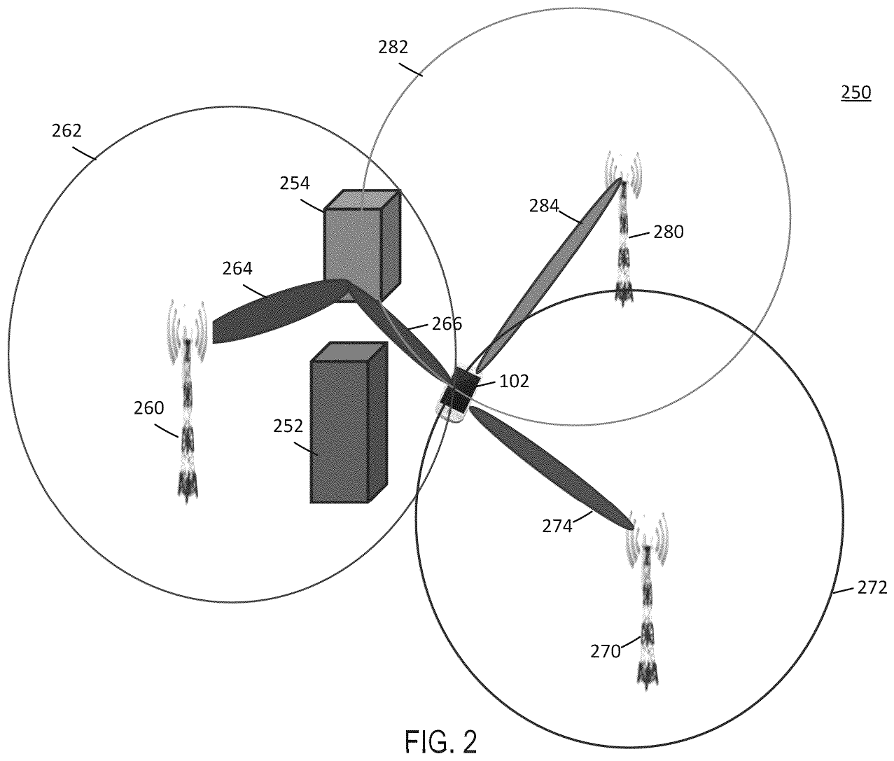

3GPP standard approaches can provide estimation techniques that are tied to time difference of arrival (TDOA), angle of arrival/departure (AoA/AoD) and roundtrip time (RTT) measurements. However, conventional mechanisms for utilizing such data and capabilities are limited in applicability and functionality. That is, they may be serviceable when there is a direct propagation (or “line of sight”—e.g., as depicted in FIG. 2, between device 102 and cell tower/gNodeB 280, for example); however, when there is an indirect route, accuracy can be substantially degraded, which can lead to a mis-estimation of a device's location, which can degrade network connectivity and/or reduce user experiences. Moreover, any indirect route, as depicted in FIG. 2, with respect to items 264 and 266, as discussed in more detail below, can cause confusion for a system, as conventional 3GPP standards are unable to discern whether the routes are linked via indirection or pertain to specific nodes that are being located. This can lead to faults and loss of connectivity within network location-based systems.

To that end, the disclosed systems and methods provide a comprehensive location (or location estimation accuracy) framework for determining and estimating the location of user equipment (UE) (e.g., mobile devices) within cellular networks. As discussed herein, the disclosed framework can execute operations that leverage a combination of Cell-ID information, GPS technology, timing measurements, and/or network-based positioning techniques to deliver accurate location information, enabling a wide range of location-based services and applications.

According to some embodiments, as discussed herein, the disclosed framework operates to leverage determined path loss values for direct and/or indirect paths between UE and cell sites (e.g., cellular coverage areas and/or cell towers (e.g., gNodeBs) to determine locations of the UE, for which network services can be based and/or provided.

In some embodiments, the path loss for an indirect path may be higher than the path loss of a direct path. This, among other potential reasons, may be due the energy being reflected off of structures (e.g., building, water tower, and the like) during indirect paths, as well as the diffraction of energy around such structures' corners, roofs and other edges or perimeters. Accordingly, as discussed below in more detail, in some embodiments, an estimated path loss associated with a cell site can be computed based on the shadowfade (e.g., fade and shadowing), which can affect the signal strength and quality of cellular signal(s). As discussed herein, fading can occur when a signal fluctuates due to multipath propagation, interference and/or distance; and shadowing can occur when a signal is blocked or attenuated by obstacles, such as buildings, trees and/or hills.

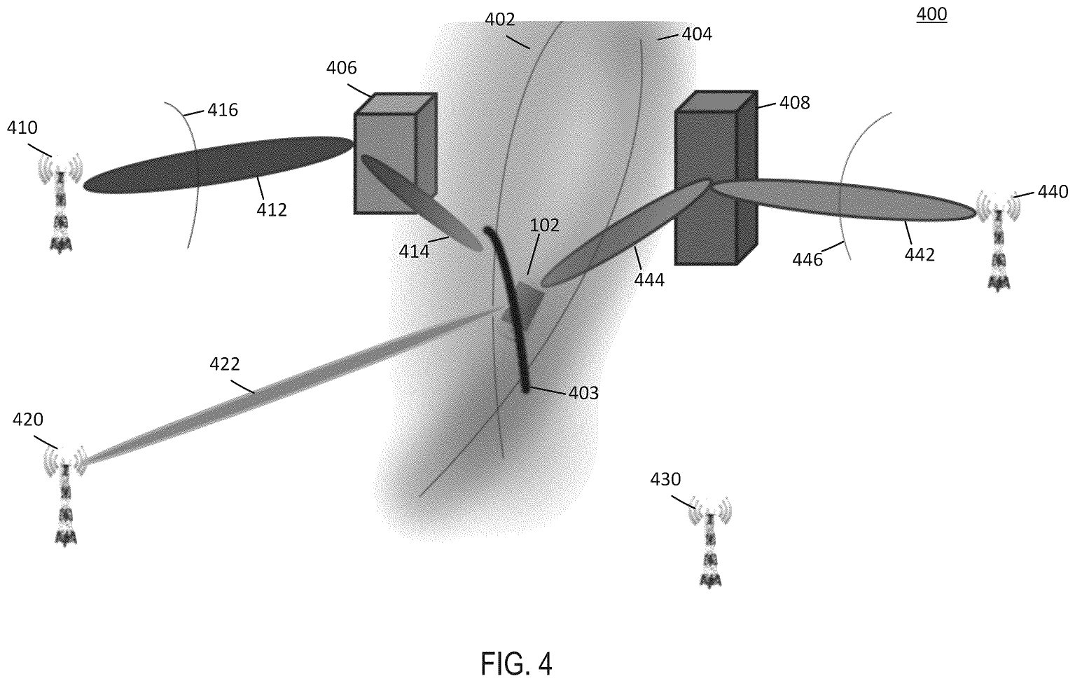

Thus, as discussed herein, shadowfade can correlate to a measured path loss minus an average path loss for that distance. Accordingly, in some embodiments, when multiple measurements conflict, thus leaving multiple candidate locations, such measurements (e.g., with a highest estimated shadow fade) can be treated as bounds (e.g., upper and lower) when determining an intersection of a device's location, as discussed below and depicted in at least FIGS. 2 and 4.

Accordingly, location estimation is a vital ability for cellular networks, with applications ranging from drone guidance and control to self-driving cars and automated factories. 3GPP has added functionality to the standards in recent releases that allows the network improved ability to measure device locations based on measurements of propagation time and angle of arrival/departure from multiple cellsites. The accuracy of these measurements depends strongly upon whether the propagation route is line of sight, or blocked, reflected and/or diffracted. Currently, there is no system or method of evaluating which measurements are accurate and which are corrupted by a non-line-of-sight pathway (e.g., indirect). Therefore, the instant disclosure provides functionality and capabilities that enables the relative accuracy of measurements to be evaluated by using measurable quantities to determine which links are non-line-of-sight so that their contributions to location estimation can be discounted (e.g., weighted appropriately in line with line-of-sight/direct links), while ensuring reliability of the prediction accuracy of a device's location.

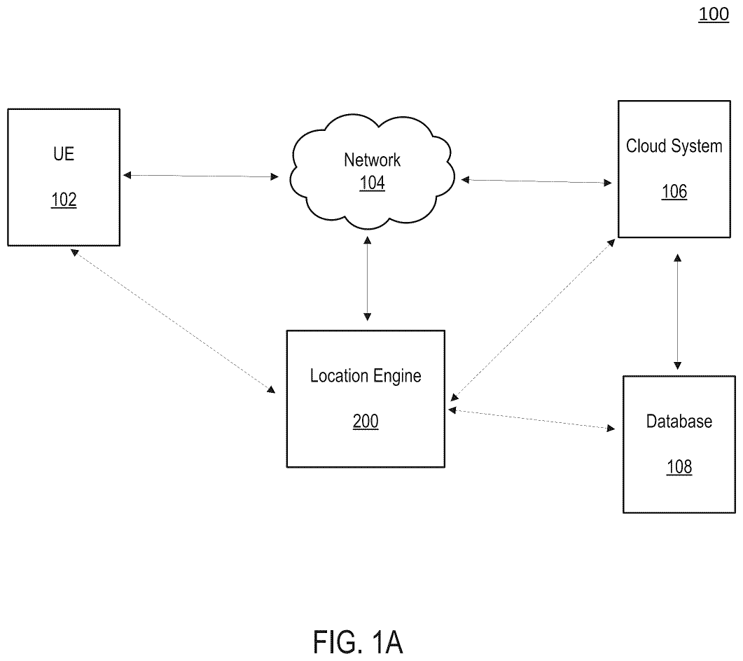

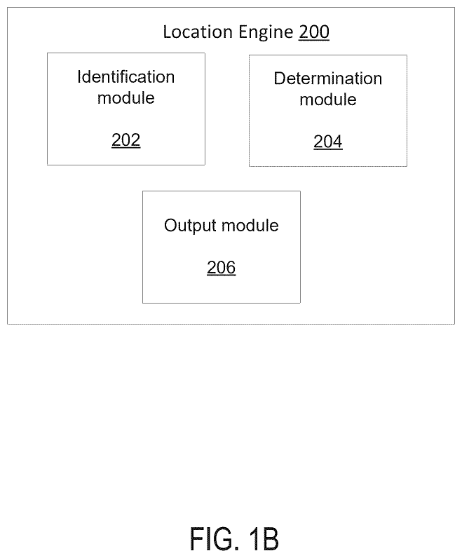

With reference to FIG. 1A, system 100 is depicted which includes user equipment (UE) 102, network 104, cloud system 106, database 108, and location engine 200. It should be understood that while system 100 is depicted as including such components, it should not be construed as limiting, as one of ordinary skill in the art would readily understand that varying numbers of UEs, engines, cloud systems, databases and networks can be utilized; however, for purposes of explanation, system 100 is discussed in relation to the example depiction in FIG. 1A.

According to some embodiments, UE 102 can be any type of network device, as discussed above. In some embodiments, for example, UE 102 can include, but not be limited to, a mobile phone, tablet, laptop, game console, smart television (TV), Internet of Things (IoT) device, wearable device, an autonomous vehicle (AV), autonomous machine, unmanned aerial vehicle (UAV), and/or any other device equipped with a cellular or wireless or wired transceiver.

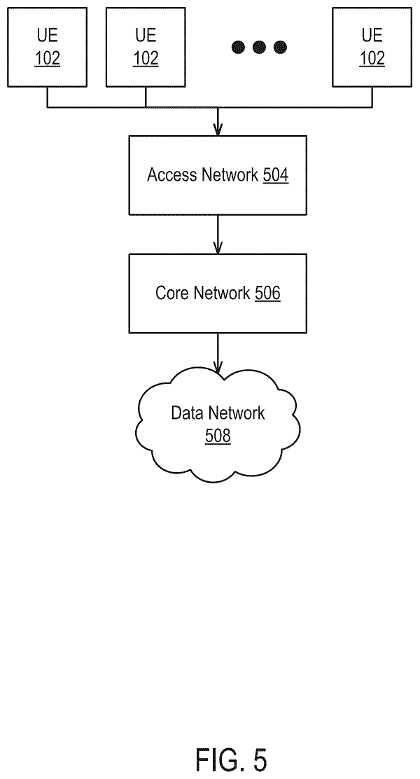

In some embodiments, network 104 can be any type of network, such as, but not limited to, a wireless network, cellular network, the Internet, and the like (as discussed above). Network 104 facilitates connectivity of the components of system 100, as illustrated in FIG. 1A. Further discussion of embodiments of network 104 are provided below with reference to FIG. 5.

According to some embodiments, cloud system 106 may be any type of cloud operating platform and/or network-based system upon which applications, operations, and/or other forms of network resources may be located. For example, system 106 may be a service provider and/or network provider from where services and/or applications may be accessed, sourced or executed from. For example, system 106 can represent the cloud-based architecture associated with a cellular provider, which has associated network resources hosted on the internet or private network (e.g., network 104), which enables (via engine 200) the location determination operations discussed herein.

In some embodiments, cloud system 106 may include a server(s) and/or a database of information which is accessible over network 104. In some embodiments, a database 108 of cloud system 106 may store a dataset of data and metadata associated with local and/or network information related to a user(s) of the components of system 100 and/or each of the components of system 100 (e.g., UE 102 and the services and applications provided by cloud system 106 and/or engine 200).

In some embodiments, for example, cloud system 106 can provide a private/proprietary management platform, whereby location engine 200, discussed infra, corresponds to the novel functionality system 106 enables, hosts and provides to a network 104 and other devices/platforms operating thereon.

According to some embodiments, database 108 may correspond to a data storage for a platform (e.g., a network hosted platform, such as cloud system 106, as discussed supra) or a plurality of platforms. Database 108 may receive storage instructions/requests from, for example, location engine 200 (and associated microservices), which may be in any type of known or to be known format, such as, for example, standard query language (SQL). According to some embodiments, database 108 may correspond to any type of known or to be known storage, for example, a memory or memory stack of a device, a distributed ledger of a distributed network (e.g., blockchain, for example), a look-up table (LUT), and/or any other type of secure data repository.

Location engine 200, as discussed above and further below in more detail, can include components for the disclosed functionality. According to some embodiments, location engine 200 may be a special purpose machine or processor, and can be hosted by a device (or component) on network 104, within cloud system 106 and/or on UE 102. In some embodiments, location engine 200 may be hosted by a server and/or set of servers associated with cloud system 106.

According to some embodiments, location engine 200 may be configured to implement and/or control a plurality of services and/or microservices, where each of the plurality of services/microservices are configured to execute a plurality of workflows associated with performing the disclosed connection management. Non-limiting embodiments of such workflows are provided below.

According to some embodiments, location engine 200 may function as an application provided by and/or hosted by cloud system 106. In some embodiments, location engine 200 may function as an application installed on a server(s), network location and/or other type of network resource associated with system 106. In some embodiments, location engine 200 may function as an application installed and/or executing on UE 102. In some embodiments, such application may be a web-based application accessed by UE 102. In some embodiments, location engine 200 may be configured and/or installed as an augmenting script, program or application (e.g., a plug-in or extension) to another application or program provided by cloud system 106 and/or executing on UE 102.

As illustrated in FIG. 1B, according to some embodiments, location engine 200 includes identification module 202, determination module 204 and output module 206. It should be understood that the modules discussed herein are non-exhaustive, as additional or fewer modules (or sub-modules) may be applicable to the embodiments of the systems and methods discussed. More detail of the operations, configurations and functionalities of location engine 200 and each of its modules, and their role within embodiments of the present disclosure will be discussed below.

FIG. 2 depicts a non-limiting example embodiment for which connectivity between a mobile device and a set of cell towers (e.g., gNodeBs) are depicted. Example 250 includes cell towers 260, 270 and 280 and UE 102. Example 250 further includes structures (or buildings, for example) 254 and 252.

As depicted in FIG. 2, each cell tower 260, 270 and 280 has a propagation path (264 and 266, 274 and 284, respectively) with/between UE 102. As discussed herein, a propagation path can refer to a trajectory followed by radio waves as they travel back and forth between a tower's antenna and the UE. This path is critical for establishing and maintaining communication within a cellular network.

In some embodiments, a propagation path can vary depending on several factors. For example, in optimal conditions, a propagation path is direct and unobstructed, known as line-of-sight propagation, resulting in minimal signal loss and strong reception. However, physical obstructions like buildings, trees, and terrain can obstruct this path, leading to signal attenuation and degradation, particularly in urban environments (e.g., as depicted in FIG. 2 as structures 252 and 254, for example). Additionally, reflections, diffraction, and multipath propagation can occur, where radio waves bounce off surfaces or bend around obstacles, creating multiple paths between the tower and the device. These phenomena can cause signal fading, interference and inaccuracies in signal strength measurements.

Therefore, as discussed herein, identifying and analyzing the metrics/values of a propagation path is critical for optimizing the location determinations of a UE's position. In some embodiment, as discussed herein, techniques, such as, for example, propagation modeling and antenna optimization can be used to mitigate signal interference and attenuation, ensuring optimal performance for mobile devices

Thus, for example, as depicted in FIG. 2, the propagation path between cell tower 260 and UE 102 is around structure 252 and between structures 252 and 254 is represented by paths 264 and 266—which represents an indirect route. The propagation path 274 corresponds to the direct (line of sight) communication link between UE 102 and cell tower 270; and propagation path 284 corresponds to the direct link between UE 102 and cell tower 280.

According to some embodiments, a propagation path can lead to shadow fading through various mechanisms, as discussed herein. Shadow fading, also known as shadowing or log-normal shadowing, refers to the phenomenon where the received signal strength fluctuates due to obstructions in the propagation path, as discussed above. A propagation path can contribute to shadow fading based on obstructions, shadowing effects, multipath propagation, and the like.

For example, with regard to obstructions (e.g., structures 252 and 254, as depicted in FIG. 2), physical objects, such as buildings, trees, and terrain along the propagation path can block or attenuate radio waves. When a UE 102 moves through an environment with varying obstructions, the signal strength experienced by the device can fluctuate significantly. This fluctuation is known as shadow fading.

With regard to shadowing effects, as a UE 102 moves relative to the surrounding environment, the UE 102 may enter and exit areas where obstructions block or attenuate the signal from the cell tower. These obstructions cast a “shadow” over a propagation path, leading to fluctuations in signal strength. The shadowing effect is particularly pronounced in urban environments with tall buildings and dense infrastructure.

Moreover, in addition to direct propagation, radio waves can also reflect off surfaces and scatter in the environment, leading to multipath propagation. When multiple copies of the signal arrive at the UE 102 with slight delays and phase differences, constructive or destructive interference can occur, causing fluctuations in signal strength and contributing to shadow fading.

Accordingly, a propagation path and shadow fading effects can vary dynamically as the UE 102 moves through different environments. Changes in terrain, foliage, weather conditions, and the presence of moving obstacles can all influence the extent and severity of shadow fading experienced by the device. Thus, shadow fading is an inherent aspect of wireless communication systems, influenced by the complex interplay of obstructions, reflections, scattering, and dynamic environmental conditions along a propagation path. As discussed herein, in some embodiments, the disclosed framework can operate to understand and mitigate shadow fading for optimizing the performance and reliability of wireless networks, particularly in urban and indoor environments where obstructions are prevalent.

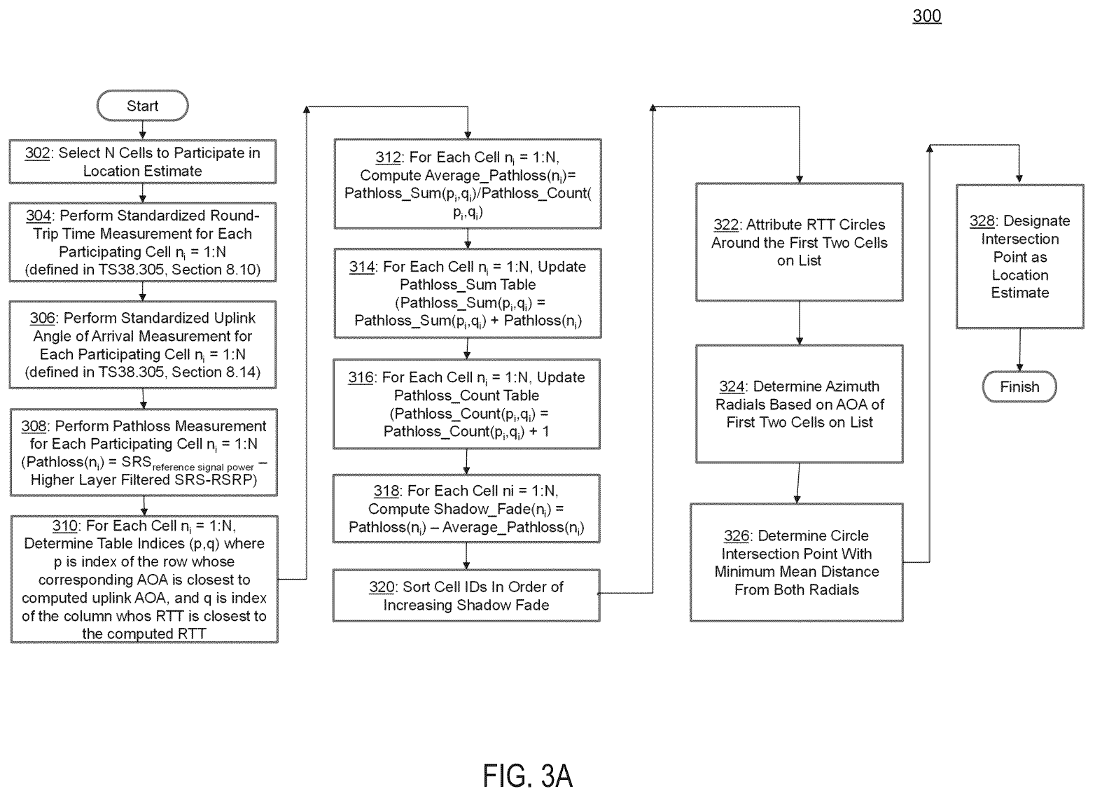

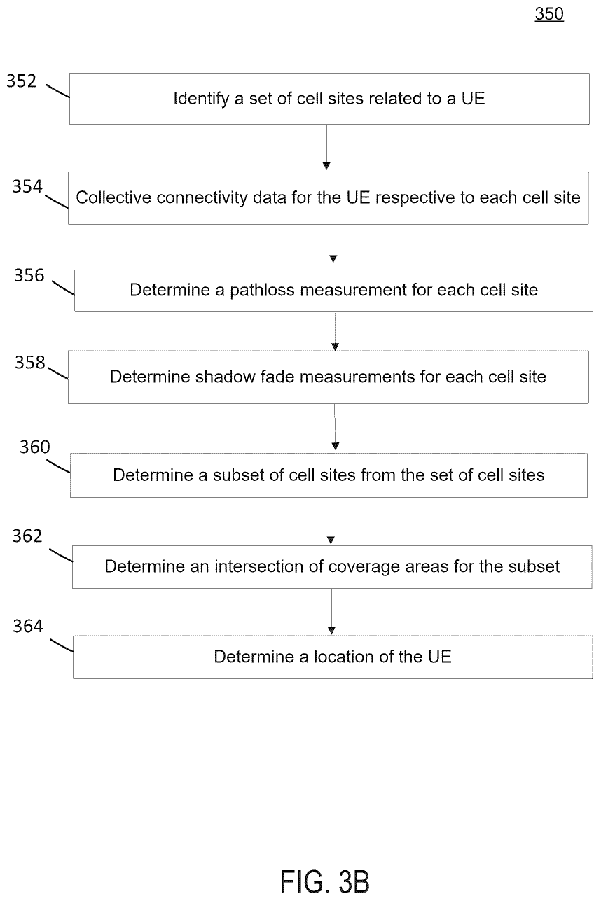

Each cell tower 260, 270 and 280 has a represented cell coverage area 262, 272 and 282, which depicts an area for which a respective cell tower can provide network connectivity and/or device identification. As discussed herein, each coverage area can intersect at UE 102, as depicted in FIG. 2, where the intersection can be based on an estimation of the position of a UE 102 via the techniques discussed below at least in relation to FIGS. 3A and 3B.

Thus, when a UE 102 communicates with the cellular network, the UE 102 can establish connections with nearby cell towers (260, 270 and 280), where each cell tower provides coverage over a specific geographic area, often referred to as a cell or cell coverage area. By analyzing the signals received from multiple cell towers, the framework can estimate the device's location based on where the coverage areas of these towers intersect, as discussed herein. According to some embodiments, such analysis and estimation can be based on, but not limited to, cell tower and/or coverage area signal strength, AoA, AoD, TDOA, RTT and the like.

In FIG. 3A, Process 300 provides non-limiting example embodiments for location estimation accuracy operations on and/or in connection with a cellular network(s) to determine and estimate the location of user equipment (e.g., mobile devices) within and/or across cellular networks. As discussed herein, engine 200's execution, via the steps of Process 300, provides functionality and capabilities that enables the relative accuracy of measurements to be evaluated by using easily-measurable quantities to determine which links are likely non-line-of-sight so that their contributions to location estimation can be discounted (e.g., weighted appropriately in line with line-of-sight/direct links).

As discussed herein, location estimates based on propagation time, RTT, and AoA/AOD are highly accurate until one or more of the cell site measurements is associated with an indirect path (e.g., such as, for example, a building or water tower reflection, building diffraction, and the like). Currently, there is no way to distinguish between such direct path and indirect path measurements (e.g., to identify which measurement may correspond to the faulty data of an indirect link).

To that end, as discussed herein, the disclosed framework leverages path loss behaviors in order to estimate and rank the relative reliabilities when multiple measurements are available that are not congruent in order to identify which link or links are most likely associated with indirect paths. In some embodiments, those links that are identified as most likely associated with indirect paths can then be adjusted or discounted appropriately by recognizing that the direct route would likely coincide with a shorter propagation distance and that the angle of arrival/departure might differ from the measured value.

According to some embodiments, Step 302 of Process 300 can be performed by identification module 202 of location engine 200; and Steps 304-326 can be performed by determination module 204; and Step 328 can be performed by output module 206.

According to some embodiments, the discussion of the steps of Process 300, infra, will be discussed with reference to the example network architecture/configuration 400 in FIG. 4. Such discussion is provided for clarity of explanation, and should not be construed as limiting in the nature of the number of devices and types of example computations performed for determining a UE's location.

According to some embodiments, Process 300 begins with Step 302 where N Cells (or cell sites or cell towers, used interchangeably) are identified and selected. In some embodiments, the N cells may correspond to the cell towers for which a UE can access the provided network coverage area. For example, as depicted in FIG. 4, UE 102 is potentially connectable (and/or connected to at least a portion of) cell towers 410, 420 and 440, where 430 is out of range, for example.

In some embodiments, a predetermined number of cells may be detectable (e.g., up to 15, for example). In some embodiments, by way of example, in (dense) urban settings, a UE 102 can decode a predetermined number of cells (e.g., more than 10, up to 15-20 cells, for example).

In some embodiments, as discussed above, each cell tower identified may have a corresponding propagation path, which may correspond to a direct link (e.g., as for path 422) or an indirect path (e.g., as for paths 444 and 446 for the path associated with UE 102's diffraction, for example, via structure 408, and paths 412 and 414 around structure 406.

In Step 304, engine 200 can perform a standardized RTT measurement for each cell tower and path. In some embodiments, such RTT measurements can be based on multi-RTT positioning for each of the identified N cells.

According to some embodiments, Multi-RTT (MTT) positioning is a sophisticated technique employed within cellular networks to accurately determine the location of UEs (e.g., mobile devices). MTT involves, upon selecting the N cells (as in Step 302) simultaneously sending a signal, known as a ranging request or probe, to each selected tower (e.g., cell towers 410, 420 and 440, for example). Upon receiving these signals, each tower promptly responds with its own signal, referred to as a ranging response, which includes precise timing information indicating when the tower received the signal from the UE 102.

Engine 200 can record the timestamps of both the signals the UE 102 sent and the responses the UE 102 received from each tower (e.g., cell towers 410, 420 and 440). This enables engine 200 to calculate the RTT for each signal. With the RTT measurements and the known speed of propagation of radio waves, engine 200 can determine a distance between the UE 102 and each tower (e.g., cell towers 410, 420 and 440). This distance calculation forms the basis of trilateration, a geometric method used to estimate the device's location by intersecting circles (or spheres in three dimensions) with known radii representing the distances to the towers (as depicted in FIG. 2 and discussed supra).

In Step 306, engine 200 can perform standardized uplink AoA (UL-AoA) measurements for each of the N cells. According to some embodiments, UL-AoA positioning is a technique utilized in cellular networks to determine the location of a mobile device by measuring the angle at which its uplink signal arrives at multiple cell towers (e.g., e.g., cell towers 410, 420 and 440). Such positioning involves the transmission of signals from the UE 102 to each cell tower (e.g., cell towers 410, 420 and 440), and analyzing the angles at which such signals arrive at each tower. Upon each tower receiving the signal, the AoA can be calculated based on the phase and timing of the signal. By comparing the AoA from multiple towers, engine 200 can triangulate the UE 102′ position. Thus, UL-AoA positioning provides the ability to determine a UE's location without additional hardware or dedicated positioning signals, and can operate in urban environments where traditional GPS signals may be obstructed.

In Step 308, engine 200 can perform a path loss measurement for each of the N Cells. As discussed herein, such path loss can be based on sounding reference signals (SRS) (e.g., as transmitted by the UE). According to some embodiments, in relation to RTT and also for OTDOA, Positioning Reference Signals (PRS) (e.g., as transmitted by a gNodeB) can be utilized to measure the path loss. In some embodiments, Primary Synchronization Signals (PSS)-Secondary Synchronization Signals (SSS) (e.g., which can be periodically transmitted by a gNodeB) can also be used to measure path loss.

According to some embodiments, path loss between UE 102 and cell towers 410, 420 and 440 can be determined using SRS as a reference power signal and higher layer filtered SRS-RSRP (Reference Signal Received Power). According to some embodiments, UE 102 can periodically transmit SRS signals over the network (e.g., network 104, discussed supra) at a predetermined power level, serving as a reference for channel estimation and quality measurement. Engine 200 can measure the power of these SRS signals, referred to as SRS-RSRP, which indicates the signal strength experienced by receiving cell towers. Path loss, influenced by factors like distance and environmental conditions, can be calculated based on the difference between the reference power signal transmitted by the device and the measured received signal power.

In some embodiments, to enhance accuracy, engine 200 can apply higher layer filtering techniques, such as averaging or smoothing, to the measured SRS-RSRP values. Various path loss models, such as, for example, a Free Space Path loss (FSPL) model, can be used to estimate signal attenuation based on known parameters, such as, for example, distance and frequency. Accordingly, in some embodiments, such path loss computation can be subject to calibration and adjustment to account for factors such as, but not limited to, antenna characteristics and propagation environment, ensuring accurate reflection of signal attenuation between the UE 102 and each cell tower (e.g., towers 410, 420 and 440).

For example, path loss can be represented as follows:

(Pathloss (nᵢ)=SRS_{reference signal power}−Higher Layer Filtered SRS-RSRP), wherein nᵢ corresponds to a cell tower (e.g., one of towers 410, 420 and 440, for example).

In Step 310, for each of the N cells, engine 200 can determine table indices based on the AoA and RTT, as discussed above. Such indices can be stored in database 108, as discussed above.

According to some embodiments, as discussed above, engine 200 can initially collect RTT and AoA measurements for the UE 102 and various cell towers (e.g., towers 410, 420 and 440). As discussed above, such measurements provide valuable information about the distance and direction of the UE 102 to each of the cell towers 410, 420 and 440. Using these measurements, engine 200 can construct a table (e.g., look-up table as a data structure) containing entries for the UE 102 and cell towers 410, 420 and 440, along with corresponding RTT and AoA values. By correlating RTT and AoA measurements for the UE 102 and cell towers 410, 420 and 440, engine 200 can update the table indices to represent the spatial distribution of UEs and/or cell tower coverage within a coverage area. This, among other benefits, enables engine 200 to accurately locate and track UEs, facilitating various location-based services and network optimization strategies.

According to some embodiments, engine 200 can determine Table Indices (p,q), where p is index of the row whose corresponding AoA is closest to computed uplink AoA, and q is index of the column whose RTT is closest to the computed RTT.

In Step 312, engine 200 can determine an average path loss. In some embodiments, the average path loss can be for each cell. That is, the average path loss can be respective to the link between the UE 102 and a respective tower. And, in some embodiments, the path loss can be across links for each of the cell towers 410, 420 and 440.

According to some embodiments, such path loss can be computed as follows:

$$Compute Average\_Pathloss ( {n}_{i} ) = Pathloss\_Sum ( {p}_{i} , {q}_{i} ) / Pathloss\_Count ( {p}_{i} , {q}_{i} ) .$$

In Step 314, engine 200 can update a path loss table based on a sum of the path loss values related to AoA and RTT, for each cell. This is represented as follows:

$$( Pathloss\_Sum ( {p}_{i} , {q}_{i} ) = Pathloss\_Sum ( {p}_{i} , {q}_{i} ) + Pathloss ( {n}_{i} )$$

Accordingly, as discussed herein, a path loss sum table is a data structure that manages information related to path loss between mobile devices and cell towers. The path loss sum table aggregates path loss values calculated for different combinations of mobile device locations and neighboring cell towers (e.g., UE 102 and cell towers 410, 420 and 440). Each entry in the table represents the cumulative path loss experienced by a mobile device when communicating with a specific set of neighboring cell towers.

Thus, as discussed herein, the path loss sum table is populated and updated based on measurements obtained from the network, such as received signal strength, round-trip time (RTT), angle of arrival (AoA), or other propagation characteristics. These measurements provide insights into the signal attenuation experienced by mobile devices as they communicate with different cell towers within the network. The path loss sum table is to support location-based services, mobility management, and network optimization. As discussed herein, by analyzing path loss values stored in the table, engine 200 can estimate the location of mobile devices more accurately, track their movements within the coverage area, and optimize resource allocation for improved network performance.

In Step 316, engine 200 can update a path loss count table for each cell (or cell tower, for example, towers 410, 420 and 440). For example, this can be represented by:

$$( Pathloss\_Count ( {p}_{i} , {q}_{i} ) = Pathloss\_Count ( {p}_{i} , {q}_{i} ) + 1 .$$

As discussed herein, a path loss count table is a data structure that can keep track of the number of occurrences of specific path loss values observed between mobile devices and cell towers (e.g., UE 102 and cell towers 410, 420 and 440). Each entry in the table represents a range of path loss values, and the corresponding count indicates how many times that particular path loss value has been measured or recorded.

In Step 318, engine 200 can compute the shadow fade for each cell. This, for example, can be represented as follows:

$$Compute Shadow\_Fade ( {n}_{i} ) = Pathloss ( {n}_{i} ) - Average\_Pathloss ( {n}_{i} ) .$$

According to some embodiments, shadow fading can be computed based on path loss and average path loss per cell by leveraging statistical relationships between these parameters. Path loss represents the attenuation of a signal as it propagates from the transmitter (cell tower 410, 420 and/or 440, for example) to the receiver (UE 102), and it includes factors, such as, for example distance, obstacles, and environmental conditions. Average path loss per cell provides an aggregate measure of path loss experienced within a specific cell coverage area.

Accordingly, in some embodiments, to determine shadow fading, the difference between the measured path loss and the average path loss per cell is analyzed. This difference reflects the variation or deviation from the average path loss, which can be attributed to large-scale fading effects like shadowing.

According to some embodiments, by analyzing a large dataset of path loss measurements collected across different locations within each cell coverage area, statistical techniques, such as, but not limited to, regression analysis and/or probability distribution fitting can be executed to characterize the variability of path loss. The observed deviations from the average path loss per cell can be modeled as a statistical distribution, typically following a log-normal distribution. This distribution captures the variability of path loss caused by factors like terrain, buildings, foliage, and other obstacles in the propagation environment.

According to some embodiments, in addition to shadow fade, the following measurement can also and/or alternatively be performed to determine line of sight path or indirect path for a UE: delay spread, Rician K-factor, fading correlation, map or table lookup, and the like. It would be understood that such measurements can be included without departing from the scope of the instant disclosure.

In Step 320, engine 200 can compile a ranking of the cells (or cell towers) based on their shadow fade values. In some embodiments, such ranking can be from highest value to lowest. In some embodiments, the ranking can be respective to identifiers (IDs) for each cell. In some embodiments, the ranking can be compiled into a data structure that can be stored in database 108 and utilized for subsequent processing, as discussed herein.

In some embodiments, the rankings can be based on a sorting or weighting of the shadow fade values. For example, if a UE is subject to an indirect path to a cell tower, then it may be weighted less, and vice versa for direct paths.

This can be represented as follows, for each cell n:

$$UE Position = Max \{ {\sum }_{∀ i} ( {w}_{n} * {I}_{n} ) \} ,$$

where wₙ=weight of Cell n;
nᵢ=1 if UE position in an area associated with coverage of a cell tower (e.g., area 402 for tower 410, for example, referred to as a “glow area,” as discussed infra); and
nᵢ=0 if UE position is NOT in a glow area.

In Step 322, engine 200 can deterministically delineate or attribute RTT circles around a top k cells (e.g., subset) within the ranked list (from Step 320). For example, the top 2 ranked cells can have RTT identifiers applied thereto. According to some embodiments, such RTT markings can be used to identify location of a UE via TDOA positioning. For example, when UE 102 communicates with a cell tower (e.g., 420, for example), engine 200 can leverage the RTT to identify such cells as nodes on the network that can be leveraged as trustworthy for subsequent processing to determine the UE 102's location at an accuracy that satisfies a TDOA threshold.

In Step 324, engine 200 can determine Azimuth radials for each cell tower. For example, as depicted in FIG. 4, if cell towers 410 and 440 are selected in Step 322, radials 416 and 446, respectively can be determined.

According to some embodiments, Azimuth radials, derived from AoA measurements, represent directional lines originating from a cell tower, indicating the angles at which signals arrive from UE 102. For example, radial 416 depicts the angle at which the signal from tower 410 arrives at UE 102. Such radials are constructed based on AoA measurements taken by a cell tower's antenna array, providing insights into the directionality of signal propagation. By drawing Azimuth radials corresponding to the measured AoA values, engine 200 can visualize potential transmission directions from the UE relative to a respective tower (e.g., a top k ranked cell).

In Step 326, engine 200 can determine intersection points for the determined Azimuth radials. According to some embodiments, the intersection point of multiple Azimuth radials can serve as an indicator of the UE 102's location. In some embodiments, via triangulation, which involves analyzing the intersecting angles from cell towers 410 and 440, for example, engine 200 can estimate the probable position of UE 102.

According to some embodiments, engine 200 can determine a precise location of UE 102, which can be performed via execution of localization algorithms that can leverage an intersection of Azimuth radials and other location data, and output such precise location, as coordinates and/or other types of location specific data.

Thus, the determination of Azimuth radials based on AoA measurements and the intersection point determination based therefrom, as in Steps 324-326 can facilitate directional localization of the UE 102.

And, in Step 328, based on the location determination discussed above (from Step 326's intersection point determination), engine 200 can designate the location estimate for the UE 102.

For example, prior to execution of the steps of Process 300, cell tower 410 would approximate UE 102 to be within the range of the angle 402 (at x,y,z coordinates as indicated by the shading), cell tower 420 would approximate UE 102 to be within the range of the angle 403 (at x,y,z coordinates as indicated by the shading), and cell tower 440 would approximate UE 102 to be within the range of the angle 404 (at x,y,z coordinates as indicated by the shading). However, this would be inaccurate, and via the disclosed processing, as culminated via Step 328, discussed supra, engine 200 can determine a precise estimation of UE 102's location.

According to some embodiments, accurate location estimation of a UE (e.g., mobile device) within a cellular network can significantly enhance both device and network performance. Firstly, accurate location information enables the provision of precise LBS to users. Applications such as navigation, emergency services, asset tracking and targeted advertising, for example, rely on accurate device location data to deliver tailored experiences and relevant information to users. By knowing the precise location of devices, LBS applications can provide more personalized and context-aware services, improving user satisfaction and engagement.

Further, accurate device location estimation enhances network performance through optimized resource allocation and efficient network management. With precise location data, network operators can better allocate network resources, such as bandwidth, power, and coverage, to meet the demand and traffic patterns in specific areas. For example, in congested areas with high user density, network resources can be dynamically adjusted to alleviate congestion and ensure quality of service.

Additionally, accurate location estimation enables improved mobility management within the network. By knowing the real-time location of devices, network operators can optimize handover processes, routing decisions, and load balancing strategies to ensure seamless connectivity and smooth transitions as devices move between cells or network areas. This enhances network reliability, reduces call drops, and improves the overall user experience.

Furthermore, accurate device location data facilitates network planning and optimization activities. Network engineers can use location information to identify coverage gaps, optimize antenna placement, plan capacity expansion, and deploy small cells or repeaters strategically to improve coverage and capacity where needed. This proactive approach to network planning helps ensure optimal network performance and efficient utilization of network resources.

Thus, accurate location estimation of devices within a cellular network contributes to improved device functionality, enhanced user experiences, and optimized network performance. By leveraging precise location data, network operators can deliver better services, manage network resources more effectively, and provide a superior mobile experience to users.

Turning to FIG. 3B, Process 350 is detailed which provides a non-limiting example embodiment of a workflow for which the steps of Process 300 can be executed. According to some embodiments, Step 302 of Process 350 can be performed by identification module 202 of location engine 200; and Steps 354-362 can be performed by determination module 204; and Step 364 can be performed by output module 206.

In some embodiments, Process 350 begins with Step 352 where engine 200 can identify a set of cell sites related to a UE. This can be performed in a similar manner as discussed in relation to at least Step 302 of Process 300, discussed supra.

In Step 354, engine 200 can collect connectivity data for the UE respective to each cell site. This can be performed in a similar manner as discussed in relation to at least Steps 304 and 306 of Process 300, discussed supra.

In Step 356, engine 200 can determine a pathloss measurement for each cell site. This can be performed in a similar manner as discussed in relation to at least Step 308 of Process 300, discussed supra.

In Step 358, engine 200 can determine shadow fade measurements for each cell site. This can be performed in a similar manner as discussed in relation to at least Steps 310-318 of Process 300, discussed supra.

In Step 360, engine 200 can determine subset of cell sites from the identified set of cell sites (from Step 302). This can be performed in a similar manner as discussed in relation to at least Steps 320-326 of Process 300, discussed supra.

In Step 362, engine 200 can determine an intersection of coverage areas for the cell sites in the determined subset. This can be performed in a similar manner as discussed in relation to at least Step 328 of Process 300, discussed supra.

And, in Step 364, engine 200 can determine a location of the UE, which as discussed above, can be based on the determined intersection from Step 362.

FIG. 5 is a block diagram of an example network architecture according to some embodiments of the present disclosure. In the illustrated embodiment, UE 102 accesses a data network 808 via an access network 504 and a core network 506.

In the illustrated embodiment, the access network 504 comprises a network allowing network communication with UE 102. In general, the access network 504 includes at least one base station that is communicatively coupled to the core network 506 and coupled to zero or more UE 102.

In some embodiments, the access network 504 comprises a cellular access network, for example, a 5G network. In an embodiment, the access network 504 can include a NextGen Radio Access Network (NG-RAN). In an embodiment, the access network 504 includes a plurality of next Generation Node B (e.g., eNodeB and gNodeB) base stations connected to UE 102 via an air interface. In one embodiment, the air interface comprises a New Radio (NR) air interface. For example, in a 5G network, individual user devices can be communicatively coupled via an X2 interface.

In the illustrated embodiment, the access network 504 provides access to a core network 506 to UE 102. In the illustrated embodiment, the core network may be owned and/or operated by a network operator (NO) and provides wireless connectivity to UE 102. In the illustrated embodiment, this connectivity may comprise voice and data services.

At a high-level, the core network 506 may include a user plane and a control plane. In one embodiment, the control plane comprises network elements and communications interfaces to allow for the management of user connections and sessions. By contrast, the user plane may comprise network elements and communications interfaces to transmit user data from UE 102 to elements of the core network 506 and to external network-attached elements in a data network 508 such as the Internet.

In the illustrated embodiment, the access network 504 and the core network 506 are operated by a NO. However, in some embodiments, the networks (504, 506) may be operated by a private entity and may be closed to public traffic. For example, the components of the network 506 may be provided as a single device, and the access network 504 may comprise a small form-factor base station. In these embodiments, the operator of the device can simulate a cellular network, and UE 102 can connect to this network similar to connecting to a national or regional network.

In some embodiments, the access network 504, core network 506 and data network 508 can be configured as a MEC network, where MEC or edge nodes are embodied as each UE 102 and are situated at the edge of a cellular network, for example, in a cellular base station or equivalent location. In general, the MEC or edge nodes may comprise UEs that comprise any computing device capable of responding to network requests from another UE 102 (referred to generally for example as a client) and is not intended to be limited to a specific hardware or software configuration of a device.

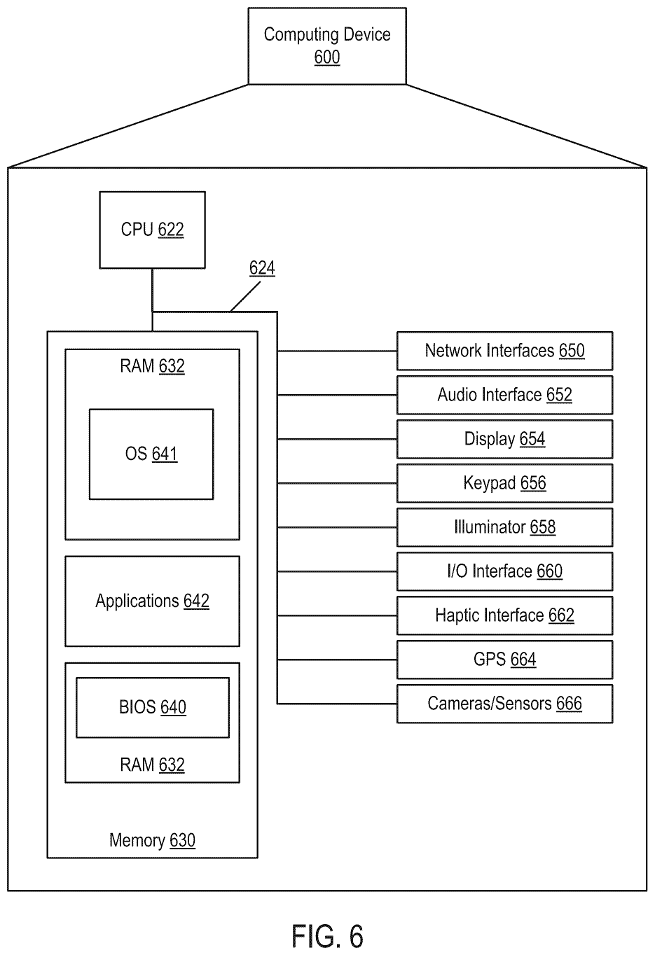

FIG. 6 is a block diagram illustrating a computing device showing an example of a client or server device used in the various embodiments of the disclosure.

The computing device 600 may include more or fewer components than those shown in FIG. 6, depending on the deployment or usage of the device 600. For example, a server computing device, such as a rack-mounted server, may not include audio interfaces 652, displays 654, keypads 656, illuminators 658, haptic interfaces 662, GPS receivers 664, or cameras/sensors 666. Some devices may include additional components not shown, such as graphics processing unit (GPU) devices, cryptographic co-processors, artificial intelligence (AI) accelerators, or other peripheral devices.

As shown in FIG. 6, the device 600 includes a CPU 622 in communication with a mass memory 630 via a bus 624. The computing device 600 also includes one or more network interfaces 650, an audio interface 652, a display 654, a keypad 656, an illuminator 658, an input/output interface 660, a haptic interface 662, an optional global positioning systems (GPS) receiver 664 and a camera(s) or other optical, thermal, or electromagnetic sensors 666. Device 600 can include one camera/sensor 666 or a plurality of cameras/sensors 666. The positioning of the camera(s)/sensor(s) 666 on the device 600 can change per device 600 model, per device 600 capabilities, and the like, or some combination thereof.

In some embodiments, the CPU 622 may comprise a general-purpose CPU. The CPU 622 may comprise a single-core or multiple-core CPU. The CPU 622 may comprise a system-on-a-chip (SoC) or a similar embedded system. In some embodiments, a GPU may be used in place of, or in combination with, a CPU 622. Mass memory 630 may comprise a dynamic random-access memory (DRAM) device, a static random-access memory device (SRAM), or a Flash (e.g., NAND Flash) memory device. In some embodiments, mass memory 630 may comprise a combination of such memory types. In one embodiment, the bus 624 may comprise a Peripheral Component Interconnect Express (PCIe) bus. In some embodiments, the bus 624 may comprise multiple busses instead of a single bus.

Mass memory 630 illustrates another example of computer storage media for the storage of information such as computer-readable instructions, data structures, program modules, or other data. Mass memory 630 stores a basic input/output system (“BIOS”) 640 for controlling the low-level operation of the computing device 600. The mass memory also stores an operating system 641 for controlling the operation of the computing device 600.

Applications 642 may include computer-executable instructions which, when executed by the computing device 600, perform any of the methods (or portions of the methods) described previously in the description of the preceding Figures. In some embodiments, the software or programs implementing the method embodiments can be read from a hard disk drive (not illustrated) and temporarily stored in RAM 632 by CPU 622. CPU 622 may then read the software or data from RAM 632, process them, and store them to RAM 632 again.

The computing device 600 may optionally communicate with a base station (not shown) or directly with another computing device. Network interface 650 is sometimes known as a transceiver, transceiving device, or network interface card (NIC).

The audio interface 652 produces and receives audio signals such as the sound of a human voice. For example, the audio interface 652 may be coupled to a speaker and microphone (not shown) to enable telecommunication with others or generate an audio acknowledgment for some action. Display 654 may be a liquid crystal display (LCD), gas plasma, light-emitting diode (LED), or any other type of display used with a computing device. Display 654 may also include a touch-sensitive screen arranged to receive input from an object such as a stylus or a digit from a human hand.

Keypad 656 may comprise any input device arranged to receive input from a user. Illuminator 658 may provide a status indication or provide light.

The computing device 600 also comprises an input/output interface 660 for communicating with external devices, using communication technologies, such as USB, infrared, Bluetooth™, or the like. The haptic interface 662 provides tactile feedback to a user of the client device.

The optional GPS transceiver 664 can determine the physical coordinates of the computing device 600 on the surface of the Earth, which typically outputs a location as latitude and longitude values. GPS transceiver 664 can also employ other geo-positioning mechanisms, including, but not limited to, triangulation, assisted GPS (AGPS), E-OTD, CI, SAI, ETA, BSS, or the like, to further determine the physical location of the computing device 600 on the surface of the Earth. In one embodiment, however, the computing device 600 may communicate through other components, providing other information that may be employed to determine a physical location of the device, including, for example, a MAC address, IP address, or the like.

The present disclosure has been described with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in some embodiments” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure has been described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure, a non-transitory computer readable medium (or computer-readable storage medium/media) stores computer data, which data can include computer program code (or computer-executable instructions) that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

To the extent the aforementioned implementations collect, store, or employ personal information of individuals, groups, or other entities, it should be understood that such information shall be used in accordance with all applicable laws concerning the protection of personal information. Additionally, the collection, storage, and use of such information can be subject to the consent of the individual to such activity, for example, through well known “opt-in” or “opt-out” processes as can be appropriate for the situation and type of information. Storage and use of personal information can be in an appropriately secure manner reflective of the type of information, for example, through various access control, encryption, and anonymization techniques (for especially sensitive information).

In the preceding specification, various example embodiments have been described with reference to the accompanying drawings. However, it will be evident that various modifications and changes may be made thereto, and additional embodiments may be implemented without departing from the broader scope of the disclosed embodiments as set forth in the claims that follow. The specification and drawings are accordingly to be regarded in an illustrative rather than restrictive sense.

What is claimed is:

1. A method comprising:
identifying, over a network, set of cell sites, each cell site comprising a coverage area for the network for user equipment (UE);
collecting, over the network, connectivity data for the UE for each coverage area, the connectivity data being based on communication signals communicated between the UE and each cell site;
analyzing the connectivity data, and determining a path loss measurement for each cell site;
determining, based on analysis of the determined path loss measurements, shadow fade measurements for each cell site, the shadow fade measurements providing an indication of signal propagation from each cell site to the UE;
determining, based on the shadow fade measurements, a subset of the set of cell sites, the subset comprising cell sites with signal measurement values satisfying a threshold;
determining an intersection of the coverage areas of the cell sites in the subset; and
determining, based on the determined intersection, a location of the UE.

2. The method of claim 1, further comprising:
providing network functionality related to at least one of network services and applications based on the determined location of the UE.

3. The method of claim 1, further comprising:
analyzing the communication signals communicated between the UE and each cell site; and
determining a round-trip time (RTT) measurement for each cell site, the RTT measurement indicating a time the communication signals take to be sent from the UE to a respective cell site, and returned, wherein the connectivity data comprises the RTT measurements.

4. The method of claim 1 further comprising:
analyzing the communication signals communicated between the UE and each cell site; and
determining a time difference of arrival (TDOA) measurement for each cell site, wherein the connectivity data comprises the TDOA measurements.

5. The method of claim 1, further comprising:
analyzing the communication signals communicated between the UE and each cell site, the communication signals comprising a respective uplink signal sent from the UE to each cell site; and
determining an uplink Angle of Arrival (UL-AoA) measurement for each cell site, the UL-AoA comprising an indication of an angle of the uplink signals sent to each cell site wherein the connectivity data comprises the UL-AoA measurements.

6. The method of claim 1, further comprising:
analyzing the communication signals communicated between the UE and each cell site, the communication signals comprising sounding reference signals (SRS) communicated by the UE to each cell site;
determining power values received by each cell site for each SRS signal; and
determining the path loss measurements for each cell site based on the determined power values.

7. The method of claim 1, further comprising:
determining, based on analysis of the connectivity data and the determined path loss measurements, an average path loss measurement for each cell site; and
determining, based further on the average path loss measurements, the shadow fade measurements, the shadow fade determination comprising weighting the analysis for each cell site based on a type of propagation path between a respective cell site and the UE.

8. The method of claim 1, further comprising:
determining Azimuth radials for each cell site in the subset based at least on the connectivity data, each Azimuth radial providing an indication a direction and angle signals arrive from the cell sites in the subset at the UE; and
determining the intersection based further on the determined Azimuth radials.

9. A device comprising:
a processor configured to:
identify, over a network, set of cell sites, each cell site comprising a coverage area for the network for user equipment (UE);
collect, over the network, connectivity data for the UE for each coverage area, the connectivity data being based on communication signals communicated between the UE and each cell site;
analyze the connectivity data, and determine a path loss measurement for each cell site;
determine, based on analysis of the determined path loss measurements, shadow fade measurements for each cell site, the shadow fade measurements providing an indication of signal propagation from each cell site to the UE;
determine, based on the shadow fade measurements, a subset of the set of cell sites, the subset comprising cell sites with signal measurement values satisfying a threshold;
determine an intersection of the coverage areas of the cell sites in the subset; and
determine, based on the determined intersection, a location of the UE.

10. The device of claim 9, wherein the processor is further configured to:
provide network functionality related to at least one of network services and applications based on the determined location of the UE.

11. The device of claim 9, wherein the processor is further configured to:
analyze the communication signals communicated between the UE and each cell site; and
determine a round-trip time (RTT) measurement for each cell site, the RTT measurement indicating a time the communication signals take to be sent from the UE to a respective cell site, and returned, wherein the connectivity data comprises the RTT measurements.

12. The device of claim 9, wherein the processor is further configured to:
analyze the communication signals communicated between the UE and each cell site; and
determine a time difference of arrival (TDOA) measurement for each cell site, wherein the connectivity data comprises the TDOA measurements.

13. The device of claim 9, wherein the processor is further configured to:
analyze the communication signals communicated between the UE and each cell site, the communication signals comprising a respective uplink signal sent from the UE to each cell site; and
determine an uplink Angle of Arrival (UL-AoA) measurement for each cell site, the UL-AoA comprising an indication of an angle of the uplink signals sent to each cell site, wherein the connectivity data comprises the UL-AoA measurements.

14. The device of claim 9, wherein the processor is further configured to:
analyze the communication signals communicated between the UE and each cell site, the communication signals comprising sounding reference signals (SRS) communicated by the UE to each cell site;
determine power values received by each cell site for each SRS signal; and
determine the path loss measurements for each cell site based on the determined power values.

15. The device of claim 9, wherein the processor is further configured to:
determine, based on analysis of the connectivity data and the determined path loss measurements, an average path loss measurement for each cell site; and
determine, based further on the average path loss measurements, the shadow fade measurements, the shadow fade determination comprising weighting the analysis for each cell site based on a type of propagation path between a respective cell site and the UE.

16. The device of claim 9, wherein the processor is further configured to:
determine Azimuth radials for each cell site in the subset based at least on the connectivity data, each Azimuth radial providing an indication a direction and angle signals arrive from the cell sites in the subset at the UE; and
determine the intersection based further on the determined Azimuth radials.

17. A non-transitory computer-readable storage medium tangibly encoded with computer-executable instructions, that when executed by a processor, perform a method comprising:
identifying, over a network, set of cell sites, each cell site comprising a coverage area for the network for user equipment (UE);
collecting, over the network, connectivity data for the UE for each coverage area, the connectivity data being based on communication signals communicated between the UE and each cell site;
analyzing the connectivity data, and determining a path loss measurement for each cell site;
determining, based on analysis of the determined path loss measurements, shadow fade measurements for each cell site, the shadow fade measurements providing an indication of signal propagation from each cell site to the UE;
determining, based on the shadow fade measurements, a subset of the set of cell sites, the subset comprising cell sites with signal measurement values satisfying a threshold;
determining an intersection of the coverage areas of the cell sites in the subset;
determining, based on the determined intersection, a location of the UE; and
providing network functionality related to at least one of network services and applications based on the determined location of the UE.

18. The non-transitory computer-readable storage medium of claim 17, further comprising:
analyzing the communication signals communicated between the UE and each cell site, the communication signals comprising a respective uplink signal sent from the UE to each cell site;
determining a round-trip time (RTT) measurement for each cell site, the RTT measurement indicating a time the communication signals take to be sent from the UE to a respective cell site, and returned, wherein the connectivity data comprises the RTT measurements;
determining a time difference of arrival (TDOA) measurement for each cell site, wherein the connectivity data comprises the TDOA measurements; and
determining an uplink Angle of Arrival (UL-AoA) measurement for each cell site, the UL-AoA comprising an indication of an angle of the uplink signals sent to each cell site.

19. The non-transitory computer-readable storage medium of claim 17, further comprising:
analyzing the communication signals communicated between the UE and each cell site, the communication signals comprising sounding reference signals (SRS) communicated by the UE to each cell site;
determining power values received by each cell site for each SRS signal;
determining the path loss measurements for each cell site based on the determined power values;
determining, based on analysis of the connectivity data and the determined path loss measurements, an average path loss measurement for each cell site; and
determining, based further on the average path loss measurements, the shadow fade measurements, the shadow fade determination comprising weighting the analysis for each cell site based on a type of propagation path between a respective cell site and the UE.

20. The non-transitory computer-readable storage medium of claim 17, further comprising:
determining Azimuth radials for each cell site in the subset based at least on the connectivity data, each Azimuth radial providing an indication a direction and angle signals arrive from the cell sites in the subset at the UE; and
determining the intersection based further on the determined Azimuth radials.
